(19) United States
(12) Patent Application Publication
(10) Pub. No.: US 2008/0263346 A1
(43) Pub. Date: Oct. 23, 2008

(54) Method and device for securely sending bootstrap message in device management

(75) Inventor: Pablo Hernandez, Paris (FR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 11/816,519

(22) PCT Filed: May 26, 2006
(86) PCT No.: PCT/KR06/02010

§ 371 Date: Aug. 16, 2007

Related U.S. Application Data
(60) Provisional application No. 60/685,158, filed on May 27, 2005.

(30) Foreign Application Priority Data
May 25, 2006 (KR) 10-2006-0047260

(51) Int. Cl. G06F 15/177

(52) U.S. Cl. 713/2

(57) ABSTRACT

A method and device for securely sending a bootstrap message from a server (i.e., a device management (DM )server) to a device in a device management system, the method comprising acquiring first information by the device, receiving, by the device, a bootstrap message from the server, acquiring, by the device, second information from the received bootstrap message, and verifying the bootstrap message by the device, whereby it is effective to securely send the bootstrap message from the server to the device by checking up whether the first information is identical to the second information.

### TECHNICAL FIELD

The present invention relates to a Device Management (DM), and more particularly, to a method and device for securely sending a bootstrap message in a DM system.

### BACKGROUND ART

In general, a DM system makes it possible to change a setting of a device by remotely controlling variables or values of objects stored in a specific device by a third party using an effective method.

The DM system according to the related art is implemented such that a DM server sends a command related to a specific Management Object (MO) existing within a device, and a DM client having received the command performs the corresponding command. Here, the MO commonly exists in a database of the device and is logically connected to a node on a DM tree which also exists within the device. That is, the DM server accesses the node, which is logically connected to the MO to desirably access, via a Uniform Resource Indicator (URI) so as to send a management command with respect to the MO.

The DM server performs DM operations such as reading, changing deleting, and generating a value of a specific MO through a process that the DM client having received the command performs the corresponding command.

The DM operations, on the other hand, may roughly be divided into two stages, namely, a bootstrapping stage and a provisioning stage.

First, the bootstrapping stage will now be explained hereafter.

The bootstrap denotes an operation for getting a certain device to a state of initiating a management session with the DM server. In addition, when the DM client (which is installed within the certain device) has already been bootstrapped, the bootstrap may be re-performed to thusly initiate a management session with new DM servers. While performing the bootstrap, setting of the device and a user application may be configured. The bootstrapping stage performed between the DM server and the device uses two profiles different from each other, namely, a DM profile and a CP profile. That is, for the DM profile, the DM server may directly send a certain MO to the device. For the CP profile, the DM sever may send the certain MO to the device to thereafter map the MO. On the other side, the bootstrapping stage may be performed by sending a bootstrap message from the DM server to the device.

Next, a DM provisioning stage will now be explained.

The DM provisioning stage denotes provisioning succeeding information from the DM server to the device after the device has been bootstrapped.

Thus, in order for a certain device to receive a DM service from a certain DM server, the bootstrapping stage should first be performed between the certain device and the certain DM server.

However, in the related art DM system, the bootstrap message is not securely sent. In other words, the certain device should be bootstrapped as a preceding stage for the DM provisioning. However, there is no method provided for securely sending the bootstrap message from the certain DM server to the certain target device.

That is, there is required a technique for securely sending the bootstrap message without concerning an exposure of bootstrap information to others so as to allow a use of the bootstrap information only between the certain device and the certain DM server to perform the bootstrapping stage.

### DISCLOSURE OF THE INVENTION

Therefore, it is an object of the present invention to provide a method and device for securely sending a bootstrap message from a DM server to a device in a DM system.

To achieve this object according to the present invention, there is provided a method for securely sending a bootstrap message in a device management comprising: acquiring first information by a device; receiving, by the device, a bootstrap message from a server; acquiring second information from the received bootstrap message by the device; and verifying the bootstrap message by the device.

Preferably, the method may further comprise bootstrapping the device when the first information is identical to the second information in verifying the bootstrap message.

To achieve this object, a device according to the present invention is characterized by acquiring first information from a smart card, receiving a bootstrap message and verifying the bootstrap message using the first information.

According to another embodiment of the present invention, a method for securely sending a bootstrap message in a device management comprises: acquiring first information by a smart card; acquiring by the smart card, second information from a bootstrap message sent by a device; and verifying, by the smart card, the bootstrap message by comparing the first information with the second information.

To achieve this object, a method for securely sending a bootstrap message in a device management according to the present invention is characterized by verifying a bootstrap message sent by a DM server, by a device, based upon authentication information of a smart card.

To achieve this object, a device according to the present invention, which is a device in a device management for securely sending a bootstrap message, is characterized by verifying a bootstrap message received from a DM server based upon authentication information of a smart card.

### EFFECT OF THE INVENTION

The present invention can be effective such that an encrypted signature (i.e., a second signature) which a certain DM server has sent together with a bootstrap message (or packet) is extracted, and it is determined whether the extracted signature is identical to a signature that a user device has, to thusly enable a verification of whether the bootstrap message is used for the certain DM server and a certain device.

In addition, whether the bootstrap message is truly related to the certain DM server and the certain device can be certified based upon the verification, it is effective to securely send the bootstrap message for the certain device, and additionally effective to maintain a security of sending of the bootstrap message according to the present invention.

### BRIEF DESCRIPTION OF THE DRAWINGS

FIG. 1 is a signal flowchart illustrating a method for securely sending a bootstrap message in a Device Management (DM) in accordance with a first embodiment of the present invention;

FIG. 2 is a signal flowchart illustrating a method for securely sending a bootstrap message in a Device Management (DM) in accordance with a second embodiment of the present invention;

FIG. 3 is a signal flowchart illustrating a method for securely sending a bootstrap message in a Device Management (DM) in accordance with a third embodiment of the present invention; and

FIG. 4 is a block diagram schematically illustrating a configuration of a device according to the present invention.

### MODES FOR CARRYING OUT THE PREFERRED EMBODIMENTS

Hereinafter, configurations and operations of preferred embodiments of the present invention will be explained with reference to the attached drawings.

The present invention conceptually relates to securely sending a bootstrap message by use of an encrypted signature (or certificate) shared by a certain DM server and a user's Integrated Circuit (IC) card (e.g., SC: smart card) when the certain DM server sends a bootstrap message to a certain device. The present invention also conceptually relates to allowing a bootstrapping of a certain device by verifying a bootstrap message (e.g., a packet-type message containing an encrypted signature and bootstrap information) that the certain device has received from a certain DM server by use of authentication information (e.g., encrypted signatures or certificates) of the smart cart.

Here, the signature is used to authenticate the DM server by the device, and used to authenticate the device by the DM server. That is, the device can check up based upon the signature and certificate whether information of the DM server is reliable, whereas the DM server can check up based upon the signature whether the device is a target device to which the DM server intends to send the bootstrap message.

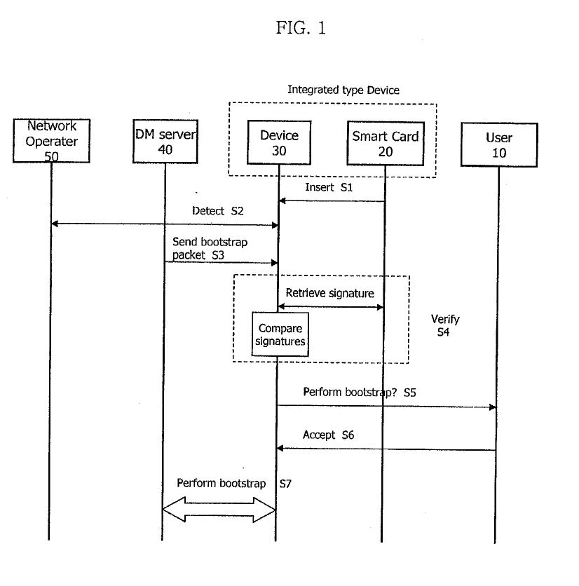

FIG. 1 is a signal flowchart illustrating a method for securely sending a bootstrap message in a Device Management (DM) in accordance with a first embodiment of the present invention.

As illustrated in FIG. 1, the present invention may include at least several physical entities for configuring a DM system, namely, a smart card 20, a device 30, a DM server 40 and a network operator 50. In addition, the smart card 20 may integrally be configured with the device 30. Furthermore, the DM server 40 and the network operator 50 may be divided according to functions thereof, and it is also possible that the two may rather be as one combined entity.

Here, a method for securely sending a bootstrap message which is performed between entities of the present invention having such configuration will now be explained.

A user 10 inserts a smart card 20 into the device 30 (S1). Here, the user 10 inserts the smart cart 20 into a newly-bought device to accordingly be able to be connected to a network that the user 10 desires to access or different applications or services. For this, a DM provisioning must be performed (not shown). That is, the user 10 requests for the DM provisioning by placing a call to a customer care or the device 30 automatically requests for the DM provisioning.

A network operator 50 detects that a new device (in which the DM provisioning is not currently being performed), namely, the device 30 exists in its network (S2). Here, the network operator 50 sends a certain signal to the DM server 40 to make the DM server 40 provide bootstrap information to subscribers (e.g., the device 30) by increasing a traffic. Accordingly, the DM server 40 sends a bootstrap message to the device 30 (S3). Here, the bootstrap message has a packet format and the packet contains every bootstrap information and signature (i.e., a so-called packet signature). Meanwhile, the signature is encoded (or encrypted) based upon a shared cryptographic mechanism.

After receiving the packet in Step S3, the device 30 compares the signature contained in the packet (i.e., the packet signature) with a signature existing in the smart cart 20 (i.e., a so-called SC signature) (S4). Here, the SC signature is encrypted based upon the shared cryptographic mechanism similar to the packet signature.

Once the SC signature is identical to the packet signature in Step S4, it is verified in the aspect of the DM server 40 that the device 30 is the target device to be bootstrapped, while it is verified in the aspect to the device 30 that the bootstrap message sent by the DM server 40 is reliable as a message for the device 30.

Hence, the device 30 requests the user's acceptance for whether to perform the bootstrap (S5). When the user 10 accepts the request (S6), the device 30 is bootstrapped using bootstrap information contained in the bootstrap packet (message) (S7).

When the SC signature is not identical to the packet signature in Step S4, on the other hand, it is determined that the bootstrap packet has been erroneously sent, and accordingly the device 30 discards the bootstrap packet.

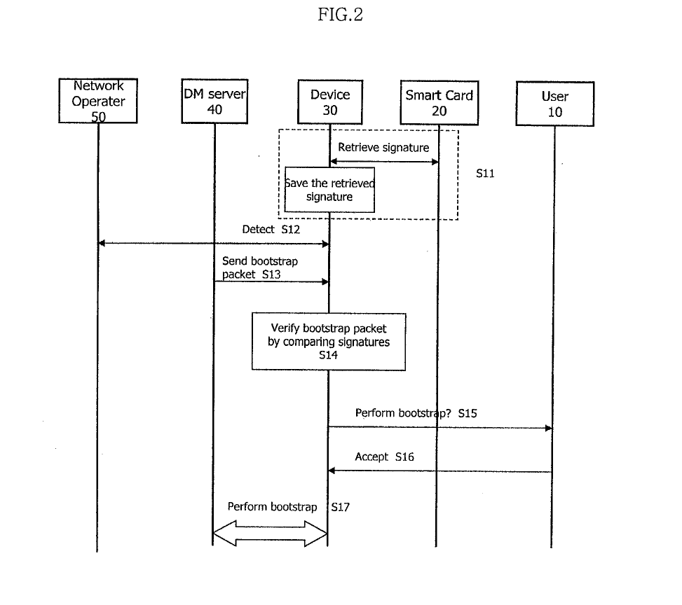

FIG. 2 is a signal flowchart illustrating a method for securely sending a bootstrap message in a Device Management (DM) in accordance with a second embodiment of the present invention.

As illustrated in FIG. 2, the present invention may include at least several physical entities for configuring a DM system, namely, a smart card 20, a device 30, a DM server 40 and a network operator 50. However, comparing the embodiment of FIG. 2 with the embodiment of FIG. 1, the embodiment of FIG. 2 is different from the embodiment of FIG. 1 in the aspect that the smart cart 20 is divided from the device 30 to thusly be an independent entity.

Hereinafter, the second embodiment of the present invention will now be explained with reference to FIG. 2.

When the user 10 inserts the smart card 20 into the device 30, the device 30 acquires (or retrieve) an SC signature contained in the smart cart 20 to store it in a certain storage unit (e.g., a memory of the device 30) (S11).

The network operator 50 detects whether there exists a device, in which the DM provisioning is not currently being performed, within its network, and thereafter sends a certain signal to the DM server 40 to make the DM server 40 provide bootstrap information to the device 30 (S12). The DM server 40 sends a packet type bootstrap message (i.e., a so-called bootstrap packet) to the device 30 (S13). Here, the bootstrap packet may contain every bootstrap information and signature (i.e., a so-called packet signature).

After receiving the packet in Step S13, the device 30 compares the packet signature (i.e., the signature contained in the packet) with the SC signature (i.e., the signature acquired from the smart card 20) stored in the certain storage unit to thusly verify the bootstrap packet by checking up the two signatures to be identical to each other (S14).

If the SC signature is identical to the packet signature in Step S14, it is verified that the device 30 corresponds to a target device to receive the bootstrap packet and it is also verified that the bootstrap packet sent by the DM server is reliable. Hence, the device 30 requests a user acceptance for whether to perform the bootstrap (S15). When the user 10 accepts the request (S16), the device 30 is bootstrapped (S17). Meanwhile, both the SC signature and the packet signature are encrypted based upon the shared cryptographic mechanism.

If the SC signature is not identical to the packet signature in Step S14, on the other hand, it is determined that the bootstrap message has been erroneously sent, and accordingly the device 30 discards the bootstrap message.

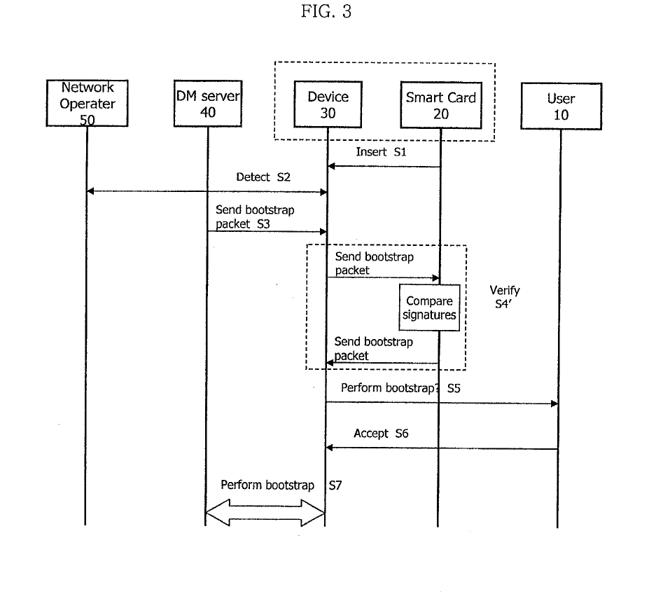

FIG. 3 is a signal flowchart illustrating a method for securely sending a bootstrap message in a Device Management (DM) in accordance with a third embodiment of the present invention. However, in the third embodiment of the present invention illustrated in FIG. 3, all of the operations except a verification step (i.e., S4′) are the same as compared with the first embodiment illustrated in FIG. 1. In order to briefly explain the present invention, the explanation for the operations of the first embodiment of the present invention illustrated in FIG. 1 will be omitted accordingly. Hereinafter, the verification step (i.e., S4′) in the third embodiment of the present invention will be explained.

As illustrated in FIG. 3, the smart card 20 may be integrated with the device 30, and a newly-bought smart card 20 may also be separately inserted into the device 30. However, in the embodiment of FIG. 3, the smart card 20 itself can extract a signature from the bootstrap message (e.g., a packet type message) and then compare it with a signature (i.e. an SC signature) that the smart card 20 itself has.

Hereinafter, the verification (S4′) of the bootstrap message (e.g., the packet type message) by comparing signatures performed by the smart card 20 will be explained. That is, when the device 30 sends the bootstrap packet received in Step S3 to the smart card 20, the smart card 20 extracts a signature contained in the bootstrap packet, and compares the extracted signature with the SC signature that the smart card 20 contains, so as to verify whether the bootstrap packet is a reliable message (i.e., a packet) used for the device 30. If the signature contained in the bootstrap packet is identical to the SC signature (i.e., the signatures are correspondent to each other), the smart card 20 re-sends the bootstrap packet to the device 30. Thereafter, succeeding processes for the bootstrapping are then performed (S4′). However, If the signature contained in the bootstrap packet is not identical to the SC signature (i.e., the signatures are not correspondent to each other), the bootstrap packet may be discarded because it is not a reliable the message for the device 30, and thereby the bootstrap may not be performed based upon the bootstrap packet (not shown).

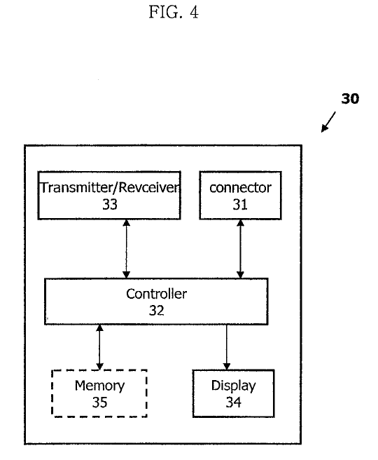

Now, with reference to FIG. 4, the embodiments of the present invention having illustrated in the aspect of the device 30 will be explained and a configuration and operation of the device 30 according to the present invention will also be explained.

FIG. 4 is a block diagram schematically illustrating a configuration of a device according to the present invention.

The device 30 aforementioned by the embodiments of the present invention may at least include a connector 31 connected to the smart card 20, a controller 32 for controlling an acquiring of a first signature (i.e., an SC signature) from the smart card 20 and an extracting of a second signature (i.e., a packet signature) from a bootstrap message, wherein when the first and second signatures are identical to each other, a display 34 is controlled to display that the signatures are identical to each other in order to inform the user whether to perform the bootstrap, a transmitter/receiver 33 for receiving the bootstrap message, and the display 34 for displaying text (or icons, animations, sound, etc.) to thereby inform the user whether to perform the bootstrap. Furthermore, the device 30 may further include a storage unit 35 for storing the first signature acquired from the smart card 20. The device 30, although not illustrated in FIG. 4, may further include essential hardware to thusly use communication services. Namely, the device 30 includes a key pad as an input unit, and a speaker as an output unit. However, such hardware based configuration and operation is obvious to a person with ordinary skill in the art to which the present invention pertains. Therefore, the configuration and operation of the basic hardware of the device which is not shown in FIG. 4 will not be explained the present invention clearly and concisely.

However, the device 30 denotes a comprehensive device which can be provided with a DM service. Hence, the device 30 may include all of the mobile communications terminals which can use the DM service via a certain mobile communication network. For example, the device 30 may include a mobile communications terminal for an audio and/or data communication, and a dedicated terminal for data communication. The device 30 may further include laptop computers, PDAs, PCMCIA cards all of which can use the DM Service, an unattended data-only device such as a vending machine, the smart card, and the like.

Functions and operations of the device 30 having such configuration will now be explained hereafter.

The device 30 receives a bootstrap message from the DM server 40 via the transmitter/receiver 33. The controller 32 verifies whether the received bootstrap message corresponds to a bootstrap message for the device 30, and then the bootstrap is performed under a certain control of the controller 32. The bootstrap message is verified by checking up (or comparing or determining) whether encrypted signatures are identical to each other. That is, the controller 32 of the device 30 acquires the first signature encrypted (i.e., the SC signature) from the smart card 20 (i.e., acquires the signature by decrypting it). The controller 32 then extracts the second signature encrypted (i.e., the packet signature) from the received bootstrap message (e.g., the packet type message), and checking up whether the first and second signatures are identical to each other. Here, whether the first and second signatures are identical to each other is determined by performing a type of calculation process, explanation of which, however, will be omitted for a brief description of the present invention. One of prior techniques can be employed to the cryptographic mechanism for the first and second signatures, explanation of which will be omitted for the brief description of the present invention.

If it is determined by the controller 32 of the device 30 that the first and second signatures are not identical to each other, the received bootstrap message is verified as the true message which is used for the device 30 and the DM server 40.

Thus, if the first and second signatures are identical to each other, whether to bootstrap the device 30 is displayed, for example, using text, icons or animation, on the display 34 under a certain control of the controller 32. When the user 10, who has checked, for example, the icons, accepts the bootstrap, the device 30 is bootstrapped under the certain control of the controller 32. Here, bootstrap information for performing the bootstrap may be included in the bootstrap message.

When the smart card 20 is a certain electronic chip type, the connector 31 of the device 30 may have a shape to be integrally connected to the smart card 20 (which is a so-called integral type connector). If the smart card 20 is a plastic card (e.g., a shape of a credit card), the connector 31 of the device 30 may have a shape which includes a certain reader for reading information contained in the smart card 20 (which is a so-called a separate type connector). If the connector 31 of the device 30 is the separate type connector, the device 30 must further include a certain storage unit 35 for acquiring (i.e., extracting) the first signature from the smart card 20 and storing the acquired first signature.

It will also be apparent to those skilled in the art that various modifications and variations can be made in the present invention without departing from the spirit or scope of the invention. For example, the term used in the present invention, namely, the smart card is just used to conveniently describe a type of integrated circuit (IC) card, but may not be limited only on the commonly used smart card. In addition, the smart card used in the present invention may include all kinds of device having such a shape as a plastic card which can perform a certain operation by having a memory and/or a microprocessor. Thus, it is intended that the present invention cover modifications and variations of this invention provided they come within the scope of the appended claims and their equivalents.

1. A method for securely sending a bootstrap message in a device management comprising:
acquiring first information by a device;
receiving, by the device, a bootstrap message from a server;
acquiring, by the device, second information from the received bootstrap message; and
verifying the bootstrap message by the device.

2. The method of claim 1, further comprising, when the first information is not identical to the second information in verifying the bootstrap message, discarding the bootstrap message by the device.

3. The method of claim 1, further comprising, bootstrapping the device when the first information is identical to the second information in verifying the bootstrap message.

4. The method of claim 1, wherein the first information and the second information are signatures shared between the device and the server.

5. The method of claim 4, wherein the first information and the second information are encrypted signatures.

6. The method of claim 1, wherein the bootstrap message is a packet.

7. The method of claim 1, wherein the bootstrap message includes at least bootstrap information and the second information.

8. The method of claim 1, wherein the first information is acquired from a user's smart card.

9. A device for acquiring first information from a smart card, receiving a bootstrap message, and verifying the bootstrap message using the first information.

10. The device of claim 9, wherein the verification of the bootstrap message is implemented by extracting second information from the bootstrap message and checking up whether the extracted second information is identical to the first information.

11. The device of claim 10, wherein when the first information is identical to the second information, the bootstrap is performed.

12. The device of claim 10, wherein when the first information is not identical to the second information, the bootstrap message is discarded.

13. The device of claim 10, wherein the first information and the second information are encrypted signatures.

14. The device of claim 9, wherein the bootstrap message includes at least bootstrap information and the second information.

15. The device of claim 9, wherein the bootstrap message is a packet.

16. A method for securely sending a bootstrap message in a device management comprising:
acquiring first information by a smart card;
acquiring, by the smart card, second information from a bootstrap message sent from a device; and
comparing the first information with the second information, and accordingly verifying the bootstrap message by the smart card.

17. The method of claim 16, further comprising, in verifying the bootstrap message:
when the first information is identical to the second information, sending the bootstrap message from the smart card to the device; and
bootstrapping the device.

18. The method of claim 16, further comprising, in verifying the bootstrap message:
when the first information is not identical to the second information, discarding the bootstrap message by the smart card.

19. The method of claim 16, wherein the first information and the second information are encrypted signatures.

20. The method of claim 16, wherein the bootstrap message is a packet, and includes at least bootstrap information and the second information.

21. A method for securely sending a bootstrap message in which a device verifies a bootstrap message sent by a device management server based upon authentication information of a smart card.

22. The method of claim 21, wherein the bootstrap message is a packet, and includes bootstrap information and a signature.

23. The method of claim 21, wherein the verification of the bootstrap message is performed on the device or the smart card.

24. A device, as a device in a device management for securely sending a bootstrap message, for verifying a bootstrap message sent by a device management server based upon authentication information of a smart card.
